(19) United States
(12) Patent Application Publication
(10) Pub. No.: US 2004/0059850 A1
(43) Pub. Date: Mar. 25, 2004

(54) Modular server processing card system and method

(76) Inventor: Christopher G. Hipp, Redwood City, CA (US)

Correspondence Address: Baker Botts L.L.P., Suite 600, 2001 Ross Avenue, Dallas, TX, 75201-2980, US

(21) Appl. No.: 10/251,432

(22) Filed: Sep. 19, 2002

(51) Int. Cl. G06F 13/00

(52) U.S. Cl. 710/100

(57) ABSTRACT

A server processing card includes a system board having a first printed circuit board operable to couple a central processing unit, a dynamic memory integrated circuit, at least first network interface integrated circuitry, and a first expansion connector. An in-line board may be coupled with the system board, the in-line board comprising a second printed circuit board, at least one component, and a second expansion connector complimentary to the first expansion connector such that the coupling of the first expansion connector with the second expansion connector allows the at least one component to cooperate with the system board to enhance functionality of the server processing card. In accordance with a particular embodiment of the present invention the second printed circuit board extends along a plane generally parallel with the first printed circuit board. The first printed circuit board and the second printed circuit board may extend along a common plane, while the first connector is coupled with the second connector.

### RELATED PATENT APPLICATIONS

The present invention is related to U.S. patent application Ser. No. 09/620,105 filed Jul. 20, 2000, entitled Single Board Web Server System and Method, and U.S. patent application Ser. No. 09/848,807 filed Jul. 23, 2001, entitled Embedded Server Chassis Hardware Master System and Method, both of which are incorporated herein for reference.

### TECHNICAL FIELD OF THE INVENTION

The present invention relates generally to computer servers and related components and, more particularly, to a modular server processing card system and method.

### BACKGROUND OF THE INVENTION

A critical component of both private intranets and the publicly accessible Internet is what is commonly referred to as a web server. A web server is typically a computer which is capable of receiving requests for information and returning data or performing specialized processing upon the receipt of a network request for such processing. Conventional network architectures envision servers as large scale computing platforms. For example, large commercial entities may include very large systems acting as web servers fielding requests for processing. Alternatively, these entities might employ large parallel server operations where a multitude of individual server computers all service requests for information and processing in parallel.

In today's network architectures, smaller users such as individuals or small businesses that require server systems will typically be forced to share part of the processing capability of one of these large scale systems. In many cases this sharing of resources does not provide adequate processing capability for the individual or small business user. Further, the sharing of a large processing system means that all parties utilizing that server processing capability are vulnerable to the failure of that system. These large processing platforms are also more difficult to customize if one small user needs specific features or components that other small users do not need. Further, as Internet and intranet traffic have grown, it has become apparent that even the largest processing platforms reach a limit to their processing capability especially in light of the increased traffic in large multimedia content and the necessity for real time processing of transactions.

Another difficulty in providing server technology to individual or small business users is associated with the difficulties in maintaining provisioning and administrating the server technology. Conventional server systems are typically very complex to administer. Software development efforts have not focused on providing simple user interfaces because the typical personnel that are tasked with maintaining servers are typically very sophisticated network technicians.

Servers and associated components are often upgraded in order to satisfy changing demands of end users, and in order to keep pace with advances in technology and enhanced product offerings. Typically, such upgrades require the replacement of the entire server, or server blade, since modification or alteration of existing servers is often expensive and time consuming.

### SUMMARY OF THE INVENTION

The present invention provides a modular server processing card system and method that substantially eliminates or reduces problems and disadvantages associated with previous methods and systems for coupling server processing card components. In particular, a server processing card includes a system board having many components which are common to different types of several processing cards. A modular in-line board includes various optional components that are specific to various applications within the server processing card industry.

In accordance with a particular embodiment of the present invention, a server processing card includes a system board having a first printed circuit board operable to couple a central processing unit, a dynamic memory integrated circuit, at least first network interface integrated circuitry, and a first expansion connector. The server processing card may also include an in-line board comprising a second printed circuit board, at least one component, and a second expansion connector complementary to the first expansion connector such that coupling of the first expansion connector with the second expansion connector allows the at least one component to cooperate with the system board to enhance functionality of the server processing card. In a particular embodiment, the second printed circuit board extends along a plane generally parallel with the first printed circuit board.

In various embodiments, the component may comprise one or more of various components which may enhance the functionality of the server processing card. For example, in accordance with at least one embodiment, the component may comprise a disk drive. In accordance with another embodiment, the component may comprise a solid state disk, with or without a battery backup power source. One or more of various other components may be coupled with the in-line board, depending on the specific application of a user of the server processing card.

Technical advantages of particular embodiments of the present invention include a modular server processing card having a fully operational system board with which one or more printed circuit boards having optional components and/or accessories may be removably coupled. The system board accommodates plug-n-play functionality with a server rack; one or more printed circuit boards having optional components and/or accessories accommodate plug-n-play functionality with the system board.

Another technical advantage of particular embodiments of the present invention includes a common, stand alone system board being configured to receive one or more of a plurality of optional boards, and no modifications to the system board are required to receive any of the one or more optional boards. Accordingly, any one of the optional boards may be coupled with the system board to provide specific functionality requested by and/or designed for a particular customer, without making any changes to the system board. As the customers needs change over time, and/or technology provides more advanced solutions, the optional board may be modified, upgraded and/or replaced, without the expense of modifying, upgrading and/or replacing the system board.

Another technical advantage of particular embodiments of the present invention include a modular server processing card having a system board which incorporates core components which are standard across an entire product line or offering. This reduces the expense of design and fabrication, since a single system board will accommodate many optional boards, without modification to the system board. In many prior art systems, any modification to a server processing card required an entire redesign which affected all components of the server processing card. In accordance with the present invention, certain standard components of the system board are unaffected by the addition of optional boards having different or enhanced functionality.

Other technical advantages will be readily apparent to one skilled in the art from the following figures, descriptions and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following descriptions, taken in conjunction with the accompanying drawings, in which:

FIG. 1A illustrates a system board including many core components of a server processing;

FIG. 1B illustrates an in-line pieced board which may be coupled with the system board to form a modular server processing card, in accordance with the particular embodiment of the present invention;

FIG. 2 illustrates the system board of FIG. 1A coupled with the in-line board of FIG. 1B;

FIG. 3 illustrates a modular server processing card having an in-line board which includes two solid state disks, in accordance with another embodiment of the present invention; and

FIG. 4 illustrates a server processing card having an in-line board which includes a disk drive and a real-time audio video encoder board, in accordance with yet another embodiment of the present invention.

### DETAILED DESCRIPTION OF THE INVENTION

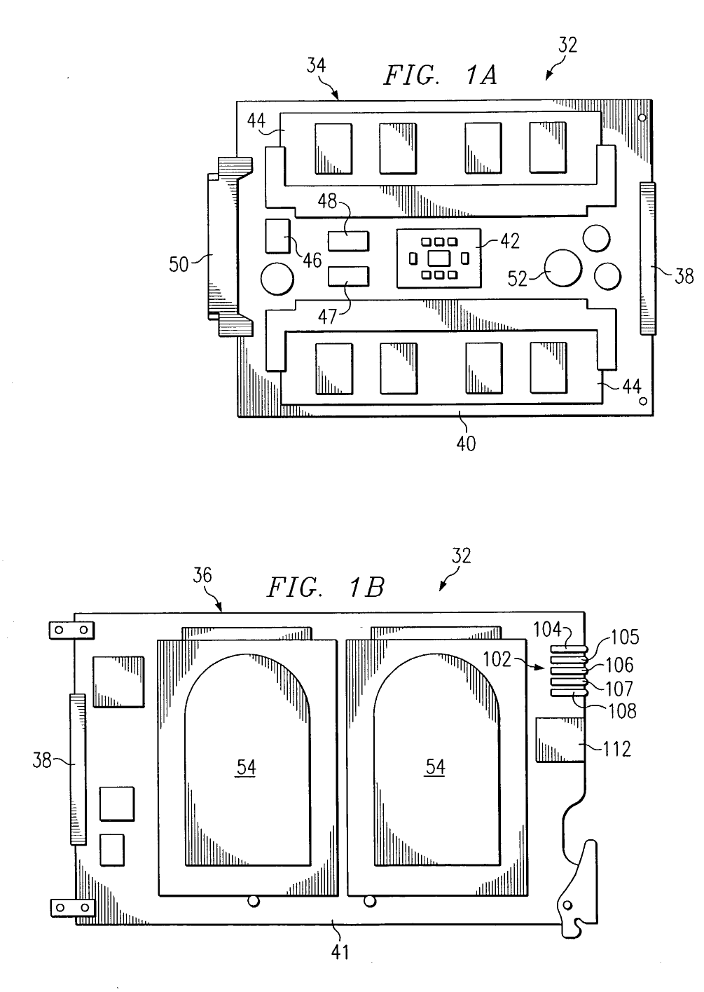

FIGS. 1A and 1B illustrate a modular server processing card 32, in accordance with a particular embodiment of the present invention. Server processing card 32 includes a system board 34 coupled with an optional in-line board 36, using an expansion connector 38. System board 34 includes many components which are common to many different types of server processing cards. In-line board 36 includes various optional components that are specific to various applications within the server processing card industry. Server processing card 32 is modular; system board 34 is fully operational and functional as a single entity (when coupled with a server rack or other network component) and may be removably coupled with one or more optional in-line boards, to provide additional, or enhanced functionality.

Expansion connectors 38 allow in-line board 36 to be removed and repaired, upgraded and/or replaced with one of various other in-line boards having different components, configurations and/or functionality. Accordingly, system board 34 may remain in service within a server chassis, while in-line board 36 is modified, upgraded, or replaced. This flexible design allows for various different configurations of in-line boards, which are each compatible with system board 34, without having to modify system board 34, to accommodate each option. Thus, manufacturing costs are reduced, and customers may be presented with various optional configurations of inline boards, to choose from. Furthermore, existing and/or operational server processing cards may be modified, enhanced, or upgraded without a customer bearing the full cost of a new server processing card.

In accordance with a particular embodiment of the present invention, server processing card 32 is a single board computer upon which all of the requisite components and devices are mounted to enable processing card 32 to function and operate as a server hosting a wide array of applications, including Internet-based applications. In one embodiment, server processing card 32 includes a powerful computer connected to the Internet and operable to store audio, video, data graphics and/or text files in order to display to a user, via protocols including, without limitation, hypertext transfer protocol (http). Server processing card 32 includes a printed circuit board 40, coupled with a central processing unit (CPU) 42, a dynamic memory integrated circuit 44, and network interface integrated circuitry 46-48.

Central processing unit 42 performs the logic, computational and decision making functions of processing card 32. Many types of central processing units with various specifications may be used within the teachings of the present invention. In the illustrated embodiment, CPU 42 includes a Crusoe TM 5800, with speeds in the range of 667 MHz to 1.2 GHz, as manufactured by Transmeta. Other CPUs, including the Crusoe TM 3200 with speeds in the range of 300-400 MHz, or TM 5400 with speeds in the range of 500-700 MHz, may also be used. In fact, many central processing units with comparable processing power, including the Pentium IV, as manufactured by Intel, may be used within the teachings of the present invention.

Server processing card 32 also includes dynamic memory integrated circuits, or memory 44. In the illustrated embodiment, memory 44 comprises two double data rate (DDR), 226 MHz, dual in-line memory module (“DIMM”) as manufactured by Kingston, to provide the appropriate speed and bandwidth for network communication. A one hundred and sixty-eight pin connector couples memory 44 with printed circuit board 40. In another embodiment, printed circuit board 40 may include one or more dual in-line memory modular slots, to accommodate DIMMs. The storage capacity of each DIMM 44 may be approximately 1 GB RAM, or greater.

In the illustrated embodiment, DIMM connectors comprise multiple pin connectors. The size and configuration of DIMM connector may be significantly altered, within the teaching of the present invention. DIMM connectors facilitate the installation of dual in-line memory modules DIMMs 44. Accordingly, web server processing card 32 can accommodate significantly more bandwidth than traditional systems which incorporate a single in-line memory module (SIMM).

Three interface integrated circuit chip sets 46-48 are coupled with printed circuit board 40. Chip set 46 may be referred to as public network interface integrated circuit since it corresponds with the operation of a public network, such as the Internet. Similarly, chip set 47 may be referred to as a private network interface integrated circuit and chip set 48 may be referred to as a management network interface integrated circuit since they correspond to private network and management network operations, respectively. Collectively, chip sets 46, 47 and 48 provide three 10/100/1000 megabits per second Ethernet network interfaces. Additional chip sets may be included with web server processing card 32 in order to support more than three independent networks. Alternatively, more or fewer than three chip sets may be used within the scope and spirit of the present invention.

Chip sets 46, 47, and 48 include “auto sensing” capability from ten megabytes and higher, such that they may operate anywhere within the range of 10/100 Ethernet to gigabit Ethernet. Accordingly, each web server processing card 32 may come equipped with three, 10/100 BaseT network interfaces, one to support the public network, one to support the private network, and one to support the management network.

A high density, eighty pin SCA connector 50 is used to couple web server processing card 32 with a server chassis. Connector 50 may also include a built-in serial connector for managing network traffic. In other words, connector 50 is appropriately sized and configured to accommodate a serial connection independent of the above Ethernet connections and any other power/communications ports incorporated into connector 50.

Server processing card 32 also includes a custom Basic Input/Output System (“BIOS”) which contains the appropriate instructions for sending information from a program to the appropriate hardware device within network 30. The BIOS of the illustrated embodiment is capable of supporting at least three independent networks corresponding to network interface integrated circuitry 46-48. Many of the other components of server processing card 32 are similar in structure and function to a typical computer motherboard (e.g., capacitors 52, integrated circuits, embedded circuitry, etc.), although support for video, keyboard and a mouse may be removed. Server processing card 32 may include two megabytes of flash read-only-memory (ROM) for BIOS storage.

Server processing card 32 includes the appropriate hardware and software to facilitate plug-n-play capability for web server processing cards 32. All of the components necessary for the operation of a web server processing card 32 are mounted upon one or more printed circuit boards. Accordingly, an unsophisticated user or operator of network 30 may install, remove and/or replace a server processing card, or portions thereof, to/from a server chassis in a single step.

System board 34 may be programmed to function as a single board computer or network server. Accordingly, system board 34 may be coupled with one or more networks to accommodate computer and/or server functionality. In a particular embodiment of the present invention, system board 34 is equipped with all of the necessary components to independently accomplish such functionality.

However, in an alternative embodiment, one or more additional “in-line” board may be coupled with the system board 34, to enhance the functionality of server processing card 32. In the illustrated embodiment, inline board 36 is coupled with system board 34, using expansion connector 38, a high density PCI expansion connector.

In-line board 36 includes dual two and one half inch disk drives 54. Disk drive 54 includes electronics, motors, and other devices operable to store (write) and retrieve (read) data on a disk. In the illustrated embodiment, each disk drive 54 includes a two and one-half half inch IBM 9.5 mm notebook hard drive. In an alternative embodiment, only a single disk drive 54 is included with in-line board 36. The use of two disk drives 54 is optional, and increases the capacity and functionality of web server processing card 32.

In various embodiments, at least two, 6 to 25 gigabyte—two and one-half inch hard drives may be provided with in-line board 36, in accordance with the teachings of the present invention. Alternatively, one or more 10 to 75 gigabyte, three and one-half inch hard drive may be installed upon in-line board 36, in lieu of two and one-half inch drives 54. Many other hard drives are suitable for use within the teachings of the present invention. In fact, many hard drives having operating temperatures of approximately 125 degrees Fahrenheit and a continuous power output of 2.5 watts may be substituted for disk drives 54 of the present invention. Accordingly, a plurality of configurations for web server processing cards 32 are envisioned within the teachings of the present invention.

Three and one-half inch disk drives offer greater spindle speed and product life. Two and one-half inch disk drives provide greater density and lower power requirements. In a particular embodiment, for efficiency purposes, each web server processing card may be based upon the same motherboard design, regardless of the number and size of the associated disk drives provided with the web server processing card.

As described above, web server processing card 32 may include a three and one-half inch disk drive, in lieu of disk drives 54. Accordingly, printed circuit board 41 includes the appropriate hardware to accommodate the three and one-half inch drive. For example, a plurality of connectors may be provided to accommodate a three and one-half inch disk drive.

Status and operation module 102 provides a user interface for determining the status and configuring web server processing cards 32. A plurality of LED indicator lights 104-108 are included with status and operation module 102. LED 104 indicates pass/fail, LED 105 indicates hard disk activity and LEDs 106-108 each indicate activity regarding an associated LAN. Server reset button 112 is also coupled with status and operation module 102, and may be used to accomplish a “hard” local reset of the associated processing card 32. A password reset button may also be provided upon status and operation module 102 and may be used to locally reset the administrative password. In other words, the password reset button may be used to erase the existing administrative password such that an operator of a network including server processing card 32 may redefine the administrative password.

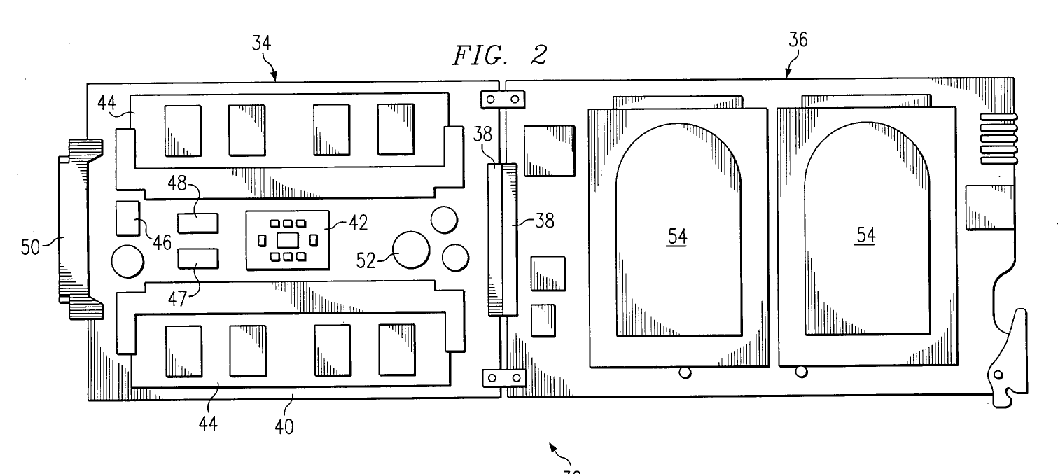

FIG. 2 illustrates system board 34 coupled with in-line PCI board 36 to form a modular server processing card. As discussed above, system board 34 may be coupled with a server chassis to perform the functionality of a computer or server. In-line board 36 enhances the functionality of server processing card 32 in cooperation with system board 34. System board 34 accommodates plug and play functionality with a server rack. In-line board 36 accommodates plug and play functionality within system board 34. In other words, in-line board 36 may be removed from system board 34 and system board 34 may remain functioning within the server rack. This allows a user to change the configuration or components of in-line board 36 as well as repair and/or upgrade components thereof. Furthermore, system board 34 may be “hotswapped” from a server chassis, and in-line board 36 may be “hot-swapped” from system board 34. In-line board 36 can then be coupled with system board 34 using connectors 38.

In the embodiment of FIG. 2, in-line board 36 includes dual two and one half inch disk drives. The disk drives are configured to provide a hardware redundant array of inexpensive disks (RAID). In-line board 36 also includes pass-through LED's, serial console and reset buttons. In-line board 36 may also include hardware accelerated iSCSI over gigabit NIC. As discussed above, in-line board 36 could be reconfigured to include one or more three and one half inch disk drives, or any other size and configuration of disk drive suitable for any particular application of a user of server processing card 32.

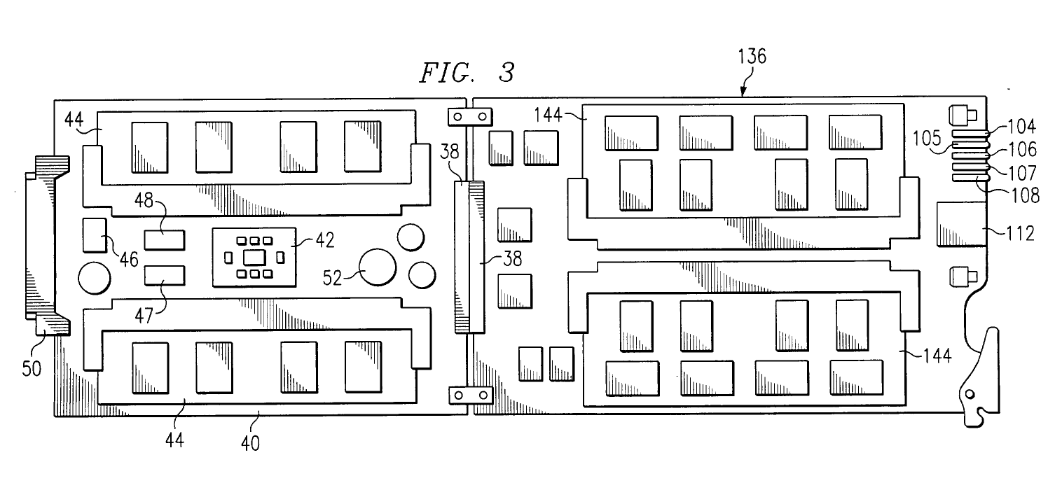

FIG. 3 illustrates a server processing card in accordance with another embodiment of the present invention. In the embodiment of FIG. 3, system board 34 remains basically unchanged from the embodiment of FIG. 2. In-line board 136 of FIG. 3 includes many of the components of in-line board 36 of FIG. 2. However, in lieu of disk drives 54, in-line board 136 includes two solid state disks 144. Solid state disks 144 may include dual in-line memory modules (DIMMs) similar to DIMMs 44 of FIG. 1A. The DIMMs of FIG. 3 may be provided with two or four gigabit storage options. Solid state storage may be appropriate for input/output (I/O) intensive applications such as BioInformatics or EDA. In general, the solid state disk option of FIG. 3 is faster than the disk drive option of FIG. 2.

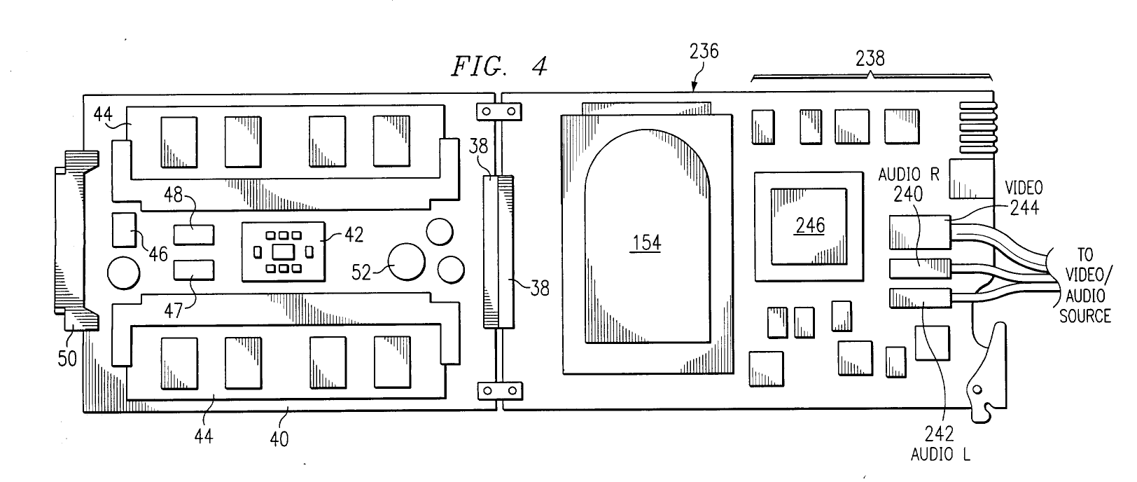

FIG. 4 illustrates a modular server processing card, in accordance with yet another embodiment of the present invention. In-line board 236 of FIG. 4 includes a two and one half inch disk drive 154 which may be configured similarly to one of disk drives 54 of FIG. 2. In-line board 236 also includes a real-time audio/video encoder board portion 238. Left and right audio input/output components 240 and 242 allow the coupling of server processing card 32 with an exterior audio source. Similarly, a video input component 244 allows server processing card 32 to be coupled with an external video source. An encoder chip 246 accomplishes audio/video processing functionality of in-line board 236. In-line board 236 may also include other components similar to in-line board 36 of FIG. 1B.

In-line boards having one or more of the components illustrated in FIGS. 1A through 4 may be configured for any application desired by a particular user of server processing card 32. Other components are also available. For example, a Fiberchannel host channel adapter may be provided upon the in-line board. This would allow the server processing card to be coupled with a Fiberchannel storage area network (SAN). In-line boards may also be provided with hardware accelerated iSCSI over gigabit NIC (a storage protocol that may be run over Ethernet). As another example, an in-line board may be provided with a second central processing unit, to increase the overall processing capacity of server processing card 32. The respective central processing units of the in-line board, and the system board may be configured for parallel, or in-line processing.

The modular server processing card of the present invention may be configured to accommodate existing chassis infrastructure. For example, the modular server processing card 32 illustrated herein may be used interchangeably with several server processing cards disclosed in co-pending U.S. patent application Ser. Nos. 09/620,105 and 09/848,807, which are hereby incorporated by reference. In fact, modular server processing card 32 may include any of the components and functionality disclosed within U.S. patent application Ser. Nos. 09/620,105 and 09/848,807, and may be used in any manner disclosed in that application.

The flexible design disclosed herein allows for various modifications and endless possibilities without having to modify the system board for each option. Instead, the in-line board may be modified and coupled with any particular system board. For example, this design allows for flexible interchangeability and use of INTEL® or TRASMETA® central processing units. The modularity allows for upgrading components separately. Since modifications do not require complete redesigns, the risk regarding new designs is thereby reduced. Manufacturing costs are also reduced since a single, standard system board may be manufactured to be used with various different in-line boards, to accommodate practically any configuration desired by any particular user.

The modular server processing part of the present invention may be more than two component boards. For example, any particular system board may be coupled with one, or any number of in-line boards simultaneously, to provide enhanced functionality. Although the illustrated includes a system board and in-line board sharing a single plane to form a continuous server processing card, other designs may include multiple parts which “piggy back” one another.

Although the present invention has been described in several embodiments, a myriad of changes and modifications may be suggested to one skilled in the art, and it is intended that the present invention encompass such changes and modifications as fall within the scope of the present appended claims.

What is claimed is:

1. A server processing card, comprising:
a system board including a first printed circuit board operable to couple a central processing unit, a dynamic memory integrated circuit, at least first network interface integrated circuitry, and a first expansion connector;
an in-line board comprising a second printed circuit board, at least one component, and a second expansion connector complementary to the first expansion connector such that coupling of the first expansion connector with the second expansion connector allows the at least one component to cooperate with the system board to enhance functionality of the server processing card; and
wherein the second printed circuit board extends along a plane generally parallel with the first printed circuit board.

2. The server processing card of claim 1, wherein the first printed circuit board and the second printed circuit board each extend along a common plane, while the first connector is coupled with the second connector.

3. The server processing card of claim 1, wherein the at least one component comprises a disk drive.

4. The server processing card of claim 3, wherein the disk drive comprises a first disk drive and wherein the in-line board further comprises a second disk drive.

5. The server processing card of claim 4, wherein the first disk drive and the second disk drive are configured to provide a redundant array of inexpensive disks.

6. The server processing card of claim 1, wherein the component comprises a solid state disk.

7. The server processing card of claim 6, wherein the solid state disk includes a battery backup power source.

8. The server processing card of claim 6, wherein the solid state disk comprises a first solid state disk, and further comprising a second solid state disk.

9. The server processing card of claim 1, wherein the component comprises a real-time audio/video encoder board.

10. The server processing card of claim 9, wherein the in-line board includes a disk drive.

11. The server processing card of claim 1, wherein the central processing unit comprises a first central processing unit, and wherein the component comprises a second central processing unit.

12. The server processing card of claim 1, wherein the component comprises a Fiberchannel host channel adapter.

13. The server processing card of claim 1, wherein the component comprises hardware accelerated iSCSI over gigabit NIC.

14. The server processing card of claim 1, further comprising a server rack connector coupled with the first printed circuit board, the server rack connector being operable to couple the server processing card with a server rack.

15. The server processing card of claim 1, wherein the first network interface integrated circuitry is operable to route public network traffic between a public network and the server processing card.

16. The server processing card of claim 1, further comprising at least second network interface integrated circuitry and third network interface integrated circuitry, wherein the second network interface integrated circuitry is operable to route private network traffic between a private network and the server processing card, and the third network interface integrated circuitry is operable to route management network traffic between a management network and the server processing card.

17. The server processing card of claim 4 wherein the first disk drive and the second disk drive are striped.

18. The server processing card of claim 4, wherein the first disk drive and the second disk drive are mirrored.

19. A method for forming a server processing card, comprising:
providing a system board including a first printed circuit board operable to couple a central processing unit, a dynamic memory integrated circuit, at least first network interface integrated circuitry, and a first expansion connector;
coupling an in-line board to the system board, the in-line board comprising a second printed circuit board, at least one component, and a second expansion connector complimentary to the first expansion connector such that coupling of the first expansion connector with the second expansion connector allows the at least one component to cooperate with the system board to enhance functionality of the server processing card; and
wherein the second printed circuit board extends along a plane generally parallel with the first printed circuit board.

20. The method of claim 19, wherein the first printed circuit board and the second printed circuit board each extend along a common plane, while the first connector is coupled with the second connector.

21. The method of claim 19, wherein the at least one component comprises a disk drive.

22. The method of claim 19, wherein the component comprises a solid state disk.

23. The method of claim 19, wherein the component comprises a real-time audio/video encoder board.

24. The method of claim 19, wherein the component comprises a Fiberchannel host channel adapter.

25. The method of claim 19, wherein the component comprises hardware accelerated ISCSI over gigabit NIC.
